(19) United States
(12) Patent Application Publication
(10) Pub. No.: US 2024/0054176 A1
(43) Pub. Date: Feb. 15, 2024

(54) PATH DETECTION DEVICE AND COMPUTER PROGRAM PRODUCT

(71) Applicants: KABUSHIKI KAISHA TOSHIBA, Tokyo (JP); TOSHIBA DIGITAL SOLUTIONS CORPORATION, Kawasaki-shi Kanagawa (JP)

(72) Inventor: Masaru SUZUKI, Ota Tokyo (JP)

(73) Assignees: KABUSHIKI KAISHA TOSHIBA, Tokyo (JP); TOSHIBA DIGITAL SOLUTIONS CORPORATION, Kawasaki-shi Kanagawa (JP)

(21) Appl. No.: 18/494,019

(22) Filed: Oct. 25, 2023

Related U.S. Application Data
(63) Continuation of application No. PCT/JP2022/017779, filed on Apr. 14, 2022.

(30) Foreign Application Priority Data
Apr. 30, 2021 (JP) 2021-077691

(51) Int. Cl. G06F 17/11; G06F 17/16

(52) U.S. Cl. CPC G06F 17/11; G06F 17/16

(57) ABSTRACT

A specific-type of simple-closed circuit in a directed graph is detected. A path detection device includes a strongly-connected-component-detection unit, a problem-generation unit, a solution acquisition unit, and a simple-closed-circuit-detection unit. The strongly-connected-component-detection unit detects a strongly-connected-component in the directed graph. The problem-generation unit generates a QUBO problem for the strongly-connected-component. The solution-acquisition unit acquires a solution of the QUBO problem for the strongly-connected-component. The simple-closed-circuit-detection unit detects a simple-closed circuit in a partial graph for the strongly-connected-component. Decision variables in an objective function in the QUBO problem correspond to nodes or edges in the strongly-connected-component. The partial graph may be a part including two or more nodes or two or more edges selected based on the solution in the strongly-connected-component. A QUBO matrix in the objective function is set such that the objective function is minimized when the partial graph satisfies a preset condition.

### CROSS-REFERENCE TO RELATED APPLICATIONS

This application is a continuation of International Application No. PCT/JP2022/017779 filed on Apr. 14, 2022 based on JP Application 2021-077691 filed on Apr. 30, 2021, the entire contents of which are incorporated herein by reference.

### FIELD

Embodiments of the embodiments herein relate to a path detection device and a computer program product.

### BACKGROUND

A technique for detecting a closed circuit included in a directed graph is known. A technique for detecting a closed circuit included in a directed graph can be used, for example, to detect a circular transaction to be audited in an inter-company transaction. For example, it is possible to detect a circular transaction between companies by generating a directed graph with a company as a node and with a payment relationship as an edge and detecting a simple closed circuit included in the generated directed graph.

As a conventional technique for detecting a closed circuit included in a directed graph, a simple closed circuit detection algorithm is known. A conventional simple closed circuit detection algorithm detects a simple closed circuit by detecting a strongly connected component included in a directed graph and performing a depth-first search on the detected strongly connected component.

However, in the conventional simple closed circuit detection algorithm, in a case where the number of nodes included in the directed graph is N, the number of edges is E, and the number of simple closed circuits is C, a calculation time of O₁×((N+E)×(C+1)) and a calculation space of O₂×(N+E) are required. Therefore, in the conventional simple closed circuit detection algorithm, it is not realistic to detect a simple closed circuit from a large-scale directed graph.

### BRIEF DESCRIPTION OF THE DRAWINGS

FIG. 1 is a diagram illustrating a functional configuration of a path detection device according to a first embodiment.

FIG. 2 is a diagram illustrating an example of a directed graph.

FIG. 3 is a diagram illustrating an example of a strongly connected component.

FIG. 4 is a diagram illustrating a first example of a simple closed circuit.

FIG. 5 is a diagram illustrating a second example of the simple closed circuit.

FIG. 6 is a flowchart illustrating processing of the path detection device according to the first embodiment.

FIG. 7 is a flowchart illustrating processing of a path detection device according to a second embodiment.

FIG. 8 is a diagram illustrating a hardware configuration of the path detection device.

### DETAILED DESCRIPTION

An object of the embodiments herein is to provide a path detection device and a computer program product capable of detecting the specific type of a simple closed circuit included in a directed graph with less calculation time and less calculation space.

A path detection device according to an embodiment detects a simple closed circuit included in a directed graph. The path detection device includes one or more hardware processors configured to function as a strongly connected component detection unit, a problem generation unit, a solution acquisition unit, a simple closed circuit detection unit, and an output unit. The strongly connected component detection unit detects one or a plurality of strongly connected components included in the directed graph. The problem generation unit generates a QUBO problem for each of the one or the plurality of strongly connected components. The solution acquisition unit acquires a solution of the QUBO problem for each of the one or the plurality of strongly connected components. The simple closed circuit detection unit detects the simple closed circuit included in a partial graph for each of the one or the plurality of strongly connected components. The output unit outputs information specifying the detected simple closed circuit. A plurality of decision variables included in an objective function in the QUBO problem corresponds to a plurality of nodes or a plurality of edges included in a strongly connected component as a target among the one or the plurality of strongly connected components. The partial graph is a part including two or more nodes or two or more edges selected based on the solution in the strongly connected component as the target. The QUBO matrix included in the objective function is set such that the objective function is minimized in a case where the partial graph satisfies a preset condition.

Hereinafter, a path detection device 10 according to an embodiment will be described with reference to the drawings.

### First Embodiment

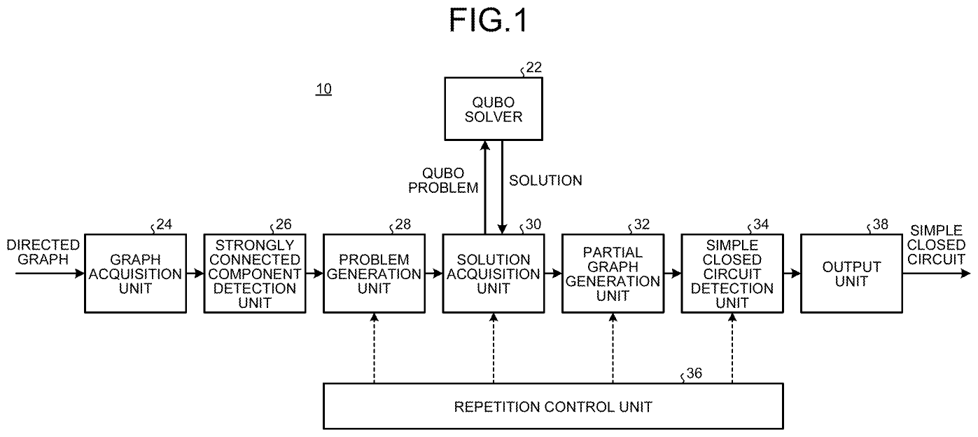

FIG. 1 is a diagram illustrating a functional configuration of a path detection device 10 according to a first embodiment.

A path detection device 10 detects a specific type of simple closed circuit included in a directed graph with less calculation time and less calculation space. In the first embodiment, the path detection device 10 detects a simple closed circuit having a large number of edges except for the number of simple closed circuits having a small number of edges stochastically among all the plurality of simple closed circuits included in the directed graph. The path detection device 10 is implemented by a processor, a computer, a server, or the like executing a program.

The path detection device 10 includes a QUBO solver 22, a graph acquisition unit 24, a strongly connected component detection unit 26, a problem generation unit 28, a solution acquisition unit 30, a partial graph generation unit 32, a simple closed circuit detection unit 34, a repetition control unit 36, and an output unit 38.

The QUBO solver 22 calculates a solution of a quadratic unconstrained binary optimization (QUBO) problem. The QUBO solver 22 receives the QUBO problem and outputs the solution to the received QUBO problem. The QUBO solver 22 may output an optimal solution or an approximate solution. The QUBO solver 22 may be a solver that calculates a solution to an Ising problem. The QUBO solver 22 is implemented by, for example, a processor or a computer that implements the path detection device 10 executing a solving program for the QUBO problem. Furthermore, the QUBO solver 22 may be provided by a server or the like. In this case, the QUBO solver 22 may be realized outside the path detection device 10. In a case where the QUBO solver 22 is implemented outside of the path detection device 10, the path detection device 10 provides the QUBO problem to the QUBO solver 22 via a network to obtain a solution from the QUBO solver 22 via the network.

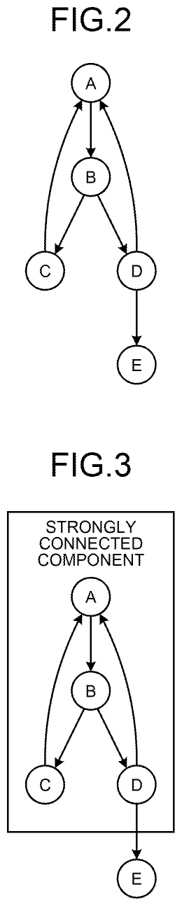

The graph acquisition unit 24 acquires a directed graph that is a target for detecting a simple closed circuit. The directed graph is described in further detail below with reference to FIG. 2.

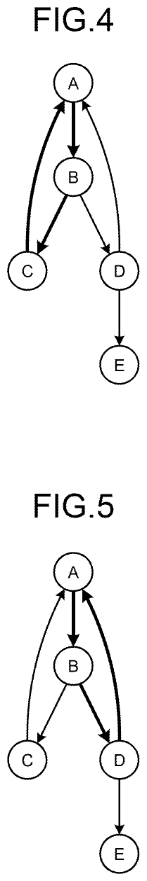

The strongly connected component detection unit 26 detects one or a plurality of strongly connected components included in the acquired directed graph. The strongly connected components are described in further detail below with reference to FIG. 3.

The problem generation unit 28 generates a QUBO problem for each of the detected one or plurality of strongly connected components. A plurality of decision variables included in an objective function in the QUBO problem corresponds to a plurality of nodes or a plurality of edges included in a strongly connected component as the target among the one or the plurality of strongly connected components. In the first embodiment, the plurality of decision variables in the QUBO problem corresponds one-to-one to the plurality of edges included in the strongly connected component as the target.

A QUBO matrix included in the objective function in the QUBO problem is set such that the objective function is minimized in a case where a partial graph satisfies a preset condition. The partial graph is a part including two or more nodes or two or more edges selected based on a solution of the QUBO problem in the strongly connected component as the target. In the first embodiment, the QUBO matrix is set such that the objective function is minimized in a case where an addition value of an input order (in-degree) and an output order (out-degree) in each of two or more nodes included in the partial graph becomes a first set value.

The solution acquisition unit 30 gives the generated QUBO problem to the QUBO solver 22 for each of the one or the plurality of strongly connected components to request a solution to the QUBO problem. Then, the solution acquisition unit 30 acquires a solution of the generated QUBO problem from the QUBO solver 22 for each of the one or the plurality of strongly connected components.

The partial graph generation unit 32 generates a partial graph selected based on the solution of the QUBO problem for each of the one or the plurality of strongly connected components. More specifically, the partial graph generation unit 32 detects, as a partial graph, a part including two or more nodes or two or more edges corresponding to the decision variable in which the solution of the QUBO problem is 1 in the strongly connected component as the target. In the present embodiment, the partial graph generation unit 32 detects, as a partial graph, a part including two or more edges corresponding to the decision variable in which the solution of the QUBO problem is 1 in the strongly connected component as the target.

The simple closed circuit detection unit 34 detects a simple closed circuit included in the partial graph for each of the one or the plurality of strongly connected components. The simple closed circuit is described in further detail below with reference to FIGS. 4 and 5.

The repetition control unit 36 repeats the generation of the QUBO problem by the problem generation unit 28, the acquisition of the solution of the QUBO problem by the solution acquisition unit 30, and the generation of the partial graph by the partial graph generation unit 32 for each of the one or the plurality of strongly connected components until the number of edges included in the partial graph becomes less than or equal to a preset threshold value.

In the second and subsequent generation processing of the QUBO problem, the repetition control unit 36 generates a new QUBO problem using a new QUBO matrix obtained by changing the QUBO matrix used in the previous process. Then, in a case where the number of edges included in the partial graph is less than or equal to the threshold value, the repetition control unit 36 ends the repetition processing and causes the simple closed circuit detection unit 34 to detect a simple closed circuit included in the partial graph. Therefore, the repetition control unit 36 can detect the simple closed circuit included in the partial graph in which the number of edges is less than or equal to the threshold value for each of the one or the plurality of strongly connected components. As a result, the repetition control unit 36 can reduce the calculation time and the calculation space for detecting the simple closed circuit.

The output unit 38 outputs simple closed circuits detected for all of the one or the plurality of strongly connected components as simple closed circuits included in the directed graph. The output unit 38 may present the detected simple closed circuits to a user by displaying the detected simple closed circuits on a display means. Furthermore, the output unit 38 may transmit the detected simple closed circuits to an external device via a network.

FIG. 2 is a diagram illustrating an example of a directed graph. The directed graph is a graph representing a connection relationship between a plurality of nodes using an edge having an orientation. A node on an input side of the edge is referred to as an original node, and a node on an output side of the edge is referred to as an output destination node.

The illustrated directed graph includes five nodes A, B, C, D, and E. Furthermore, the illustrated directed graph includes six edges. The six edges include an edge from A to B (A→B), an edge from B to C (B→C), an edge from C to A (C→A), an edge from B to D (B→D), an edge from D to A (D→A), and an edge from D to E (D→E).

FIG. 3 is a diagram illustrating an example of a strongly connected component. The strongly connected component is a graph of a part of a directed graph, and is a maximum graph including a path that can be bidirectionally moved back and forth between any two nodes.

As illustrated in FIG. 3, the strongly connected components included in the illustrated directed graph are graphs including A, B, C, and D. In the graph including A, B, C, and D, in a case where any two nodes of A, B, C, and D are selected, there is a path that can be bidirectionally moved back and forth. Moreover, a graph including A, B, C, and D does not result in a strongly connected component when any other nodes are added. Therefore, the graph including A, B, C, and D is a part of the illustrated directed graph, and is a maximum graph including a path that can be bidirectionally moved back and forth between any two nodes.

FIG. 4 is a diagram illustrating a first example of a simple closed circuit. FIG. 5 is a diagram illustrating a second example of the simple closed circuit. The closed circuit is a path that starts from a certain node and returns to the started node. The simple closed circuit is a path in which there are no overlapping nodes in the closed circuit, that is, two or more identical nodes are not included.

As illustrated in FIG. 4, one of the simple closed circuits included in the illustrated directed graph is a path of A→B→C→A. Furthermore, as illustrated in FIG. 5, one of the simple closed circuits included in the illustrated directed graph is a path of A→B→D→A.

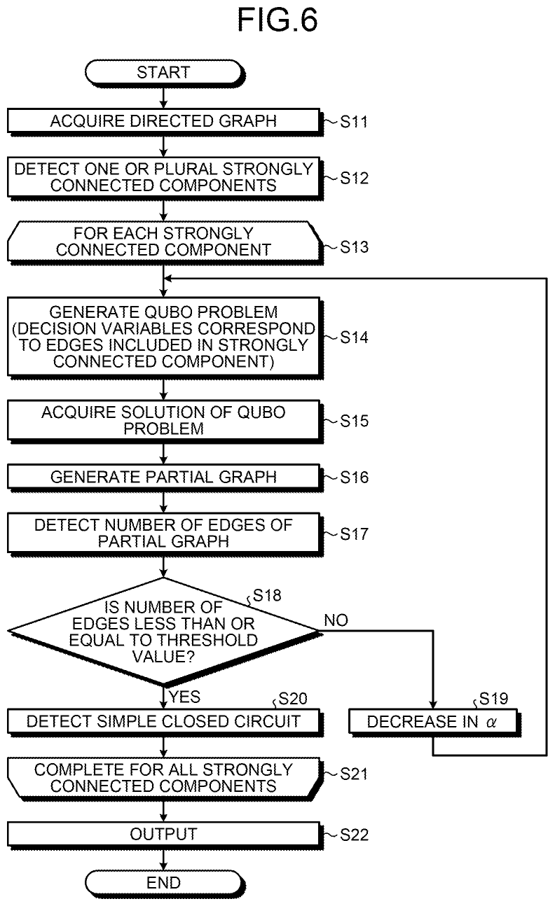

FIG. 6 is a flowchart illustrating a flow of processing of the path detection device 10 according to the first embodiment. The path detection device 10 executes processing according to the flow illustrated in FIG. 6.

First, in S11, the graph acquisition unit 24 acquires a directed graph that is a target for detecting a simple closed circuit.

For example, the graph acquisition unit 24 acquires information in which an original node and an output destination node are described for each of a plurality of edges included in a directed graph as illustrated in Table 1. Note that the graph acquisition unit 24 is not limited to such a description, and may acquire a directed graph described by another method.

TABLE 1

| | | Output destination |
|---|---|---|
| Edge index | Original node | node |
| 1 | A | B |
| 2 | B | C |
| 3 | C | A |
| 4 | B | D |
| 5 | D | A |
| 6 | D | E |

Subsequently, in S12, the strongly connected component detection unit 26 analyzes the acquired directed graph and detects one or a plurality of strongly connected components included in the acquired directed graph. As an example, the strongly connected component detection unit 26 can detect a strongly connected component from the directed graph using a Tarjan's algorithm disclosed in Non Patent Literature 3.

Subsequently, the path detection device 10 executes processing from S14 to S20 for each of the one or the plurality of strongly connected components (loop processing between S13 and S21).

In S14, the problem generation unit 28 generates the QUBO problem for the strongly connected component in interest to be subjected to the processing from S14 to S20. In the first embodiment, the plurality of decision variables included in the objective function in the QUBO problem corresponds one-to-one to the plurality of edges included in the strongly connected component as the target.

Subsequently, in S15, the solution acquisition unit 30 gives the generated QUBO problem to the QUBO solver 22 for the strongly connected component as the target, and requests a solution to the QUBO problem. Then, the solution acquisition unit 30 acquires a solution of the generated QUBO problem for the strongly connected component as the target from the QUBO solver 22.

Subsequently, in S16, the partial graph generation unit 32 generates a partial graph selected on the basis of the solution of the QUBO problem for the strongly connected component as the target. More specifically, the partial graph generation unit 32 detects, as a partial graph, a part including two or more nodes or two or more edges corresponding to the decision variable in which the solution of the QUBO problem is 1 in the strongly connected component as the target. In the first embodiment, the partial graph generation unit 32 detects, as a partial graph, a part in the strongly connected component as the target that includes two or more edges corresponding to the decision variable in which the solution of the QUBO problem is 1 and that does not include an edge corresponding to the decision variable in which the solution is 0.

Here, in the first embodiment, the problem generation unit 28 generates a function illustrated in Formula (1) as an objective function in the QUBO problem.

$${\sum }_{i = 1}^{E} {\sum }_{j = 1}^{E} {x}_{i} \cdot {Q}_{i , j} \cdot {x}_{j} \qquad ( 1 )$$

Where, E is the number of edges included in the strongly connected component as the target. i and j are integers of 1 or more and E or less and represent indices of edges. xᵢ is a decision variable corresponding to the i-th edge among the E edges. xⱼ is a decision variable corresponding to the j-th edge among the E edges.

Q_{i,j} is a coefficient multiplied by a set of the decision variable corresponding to the i-th edge and the decision variable corresponding to the j-th edge included in the QUBO matrix.

In the first embodiment, the QUBO matrix is an E×E square matrix. In the first embodiment, the QUBO matrix is set such that the objective function is minimized in a case where an addition value of an input order and an output order in each of the two or more nodes included in the partial graph becomes the first set value. The input order is the number of edges entering the node. The output order is the number of edges exiting the node.

In the first embodiment, Q_{i,j}, which is a coefficient included in the QUBO matrix, is expressed by Formula (2).

$${Q}_{i , j} = {Q}_{i , j}^{α} + {Q}_{i , j}^{source} + {Q}_{i , j}^{destination} \qquad ( 2 )$$

$${Q}_{i , j}^{α} = \{ \begin{matrix}- 4 α & if i = j \\ 0 & if i \neq j\end{matrix}$$

$${Q}_{i , j}^{source} = \{ \begin{matrix}+ 1 & if {source}_{i} = {source}_{j} \\ 0 & if {source}_{i} \neq {source}_{j}\end{matrix}$$

$${Q}_{i , j}^{destination} = \{ \begin{matrix}+ 1 & if {destination}_{i} = {destination}_{j} \\ 0 & if {destination}_{i} \neq {destination}_{j}\end{matrix}$$

Where, Q^{α}_{i,j} is the first term of the coefficient multiplied by a set of the decision variable corresponding to the i-th edge and the decision variable corresponding to the j-th edge. Q^{source}_{i,j} is the second term of the coefficient multiplied by a set of the decision variable corresponding to the i-th edge and the decision variable corresponding to the j-th edge. Q^{destination}_{i,j} is the third term of the coefficient multiplied by a set of the decision variable corresponding to the i-th edge and the decision variable corresponding to the j-th edge.

sourceᵢ represents an original node of the i-th edge. sourceⱼ represents an original node of the j-th edge. destinationᵢ represents an output destination node of the i-th edge. destinationⱼ represents an output destination node of the j-th edge.

Then, α is a positive real number. For example, an initial value of α is set by a user or the like.

Q^{α}_{i,j}, which is the first term of the coefficient, represents that −4α is added to the coefficients of the diagonal components of the QUBO matrix and 0 is added to the coefficients other than the diagonal components. Q^{source}_{i,j}, which is the second term of the coefficient, represents that +1 is added to the coefficient corresponding to the set of two edges in which the original edges are common, and 0 is added to the coefficient corresponding to the set of two edges in which the original edges are not common. Q^{destination}_{i,j}, which is the third term of the coefficient, represents that +1 is added to the coefficient corresponding to the set of two edges in which the output destination edges are common, and 0 is added to the coefficient corresponding to the set of two edges in which the output destination edges are not common.

For example, in a case where Formula (2) is executed for the strongly connected component included in the directed graph illustrated in Table 1, the problem generation unit 28 can generate the QUBO matrix illustrated in Table 2 below.

TABLE 2

| | i | | | | |
|---|---|---|---|---|---|
| j | A→B(1) | B→C(2) | C→A(3) | B→D(4) | D→A(5 = E) |
| A→B(1) | 2-4 α | 0 | 0 | 0 | 0 |
| B→C(2) | 0 | 2-4 α | 0 | 1 | 0 |
| C→A(3) | 0 | 0 | 2-4 α | 0 | 1 |
| B→D(4) | 0 | 1 | 0 | 2-4 α | 0 |
| D→A(5 = E) | 0 | 0 | 1 | 0 | 2-4 α |

The objective function including the QUBO matrix calculated according to Formula (2) has a minimum value in a case where values of the N decision variables are selected such that an addition value of the input order and the output order at each of the two or more nodes included in the partial graph is 2×α. That is, the QUBO problem using the objective function including the QUBO matrix calculated according to Formula (2) returns the global minimum value in the vicinity where the addition value of the input order and the output order in each of the two or more nodes included in the partial graph is 2×α. Note that 2×α is a value corresponding to the first set value.

Therefore, the QUBO problem using the objective function including the QUBO matrix calculated according to Formula (2) can return a solution such that the edge is removed from the node in which the addition value of the input order and the output order is larger than 2×α among the strongly connected components as the target, and the edge of the node in which the addition value of the input order and the output order is 2×α or less is left. Therefore, the QUBO problem using the objective function including the QUBO matrix calculated according to Formula (2) can return a solution for selecting a partial graph in which multiple edges and multiple paths are removed with high probability.

Note that the QUBO matrix is not limited to the matrix shown in Formula (2), and may be another matrix. For example, the QUBO matrix may be a matrix obtained by multiplying the matrix shown in Formula (2) by coefficients. Furthermore, Q^{α}_{i,j}, which is the first term of the coefficient in the QUBO matrix, may not add −4α to the coefficients of the diagonal components of the QUBO matrix, but may add −1×A×α. Note that A is a positive integer.

Subsequent to S16, in S17, the repetition control unit 36 detects the number of edges of the generated partial graph. Subsequently, in S18, the repetition control unit 36 determines whether or not the number of edges included in the generated partial graph is less than or equal to a preset threshold value for the strongly connected component as the target. In a case where the number of edges included in the generated partial graph is larger than the threshold value (No in Step S18), the repetition control unit 36 advances the processing to S19.

In S19, the repetition control unit 36 decreases α used for calculation of the QUBO matrix by a predetermined amount. After completing S19, the repetition control unit 36 returns the processing to S14. Then, the problem generation unit 28 repeats the processing from S14.

The number of edges included in the partial graph is proportional to the total of the entire partial graph of an addition value of the input order and the output order at the node. Therefore, the number of edges included in the partial graph monotonically increases as α increases. Therefore, the repetition control unit 36 can control the number of edges included in the partial graph to a target value by changing α and repeating generation of the QUBO problem and generation of the partial graph. For example, the repetition control unit 36 can control the number of edges included in the partial graph to the target value by the binary search.

In a case where the number of edges included in the partial graph is less than or equal to the threshold value (Yes in Step S18), the repetition control unit 36 advances the processing to S20.

In S20, the simple closed circuit detection unit 34 detects a simple closed circuit included in the partial graph for each of the strongly connected components as the target. For example, the simple closed circuit detection unit 34 detects a simple closed circuit from the partial graph by depth-first search processing. For example, the simple closed circuit detection unit 34 can detect a simple closed circuit included in the partial graph using Johnson's algorithm described in Non Patent Literature 2.

In S21, the path detection device 10 determines whether or not the processing from S14 to S20 has been executed for all of the one or the plurality of strongly connected components. In a case where the execution has not been completed for all of the one or the plurality of strongly connected components, the path detection device 10 executes the processing from S14 to S20 for the unexecuted strongly connected component. In a case where the processing from S14 to S20 has been completed for all of the one or the plurality of strongly connected components, the path detection device 10 advances the processing to S22.

In S22, the output unit 38 outputs the simple closed circuits detected for all of the one or the plurality of strongly connected components. Upon completion of S22, the path detection device 10 ends this flow.

The path detection device 10 according to the first embodiment as described above detects, for each of the one or the plurality of strongly connected components included in the directed graph, a partial node so as to exclude an edge from a node having a large addition value of the input order and the output order and not to exclude an edge from a node having a small addition value of the input order and the output order. As a result, the path detection device 10 can detect the partial graph in which the multiple edges and the multiple paths are removed from the directed graph with high probability.

Then, the path detection device 10 detects the simple closed circuit from such a partial graph. Therefore, the path detection device 10 can detect the simple closed circuit having a large number of edges included in the directed graph with a small calculation time and a small calculation space.

### Second Embodiment

Next, a path detection device 10 according to a second embodiment will be described. The path detection device 10 according to the second embodiment detects a specific type of simple closed circuit included in a directed graph with less calculation time and less calculation space. In the present embodiment, the path detection device 10 detects a simple closed circuit having a small number of edges except for the number of simple closed circuits having a large number of edges stochastically among all the plurality of simple closed circuits included in the directed graph.

Note that the path detection device 10 according to the second embodiment has the same block configuration as that of the first embodiment, and has substantially the same function. In the second embodiment, coefficients, variables, functional blocks, and steps that are the same as or correspond to those in the first embodiment will be denoted by the same symbols or signs and will not be described as appropriate, and differences will be mainly described.

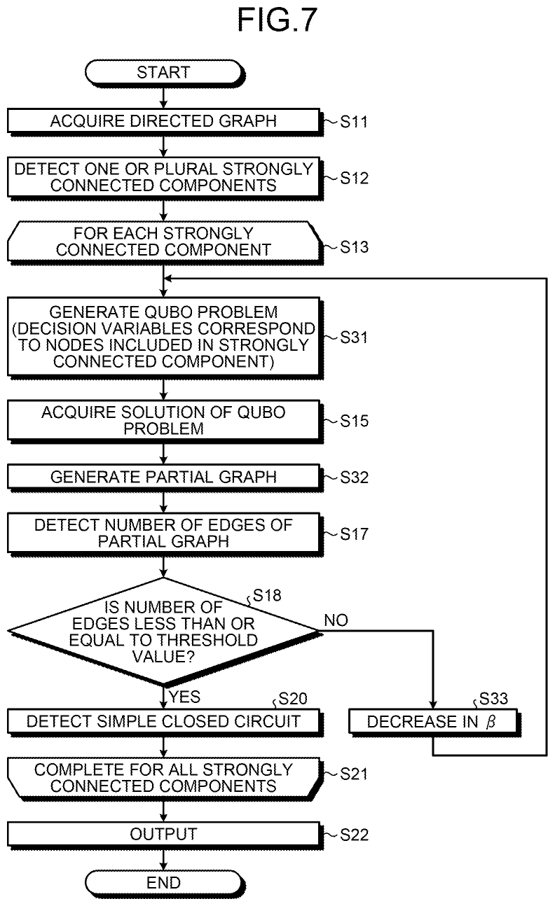

FIG. 7 is a flowchart illustrating a flow of processing of the path detection device 10 according to the second embodiment. The path detection device 10 according to the second embodiment executes processing in the flow illustrated in FIG. 7.

The processing of the path detection device 10 according to the second embodiment is different from the processing of the first embodiment illustrated in FIG. 6 in that S31 is performed instead of S14, S32 is performed instead of S16, and S33 is performed instead of S19.

First, in S11, the graph acquisition unit 24 acquires a directed graph. Subsequently, in S12, the strongly connected component detection unit 26 detects one or a plurality of strongly connected components included in the acquired directed graph.

Subsequently, the path detection device 10 executes processing from S31 to S20 for each of the one or the plurality of strongly connected components (loop processing between S13 and S21).

In S31, the problem generation unit 28 generates the QUBO problem for the strongly connected component as the target. In the second embodiment, the plurality of decision variables included in the objective function in the QUBO problem corresponds one-to-one to the plurality of nodes included in the strongly connected component as the target.

Subsequently, in S15, the solution acquisition unit 30 gives the generated QUBO problem to the QUBO solver 22 for the strongly connected component as the target, and requests a solution to the QUBO problem. Then, the solution acquisition unit 30 acquires a solution of the generated QUBO problem for the strongly connected component as the target from the QUBO solver 22.

Subsequently, in S32, the partial graph generation unit 32 generates a partial graph selected on the basis of the solution of the QUBO problem for the strongly connected component as the target. In the second embodiment, the partial graph generation unit 32 detects, as a partial graph, a part in the strongly connected component as the target that includes two or more nodes corresponding to the decision variable in which the solution of the QUBO problem is 1 and does not include a node corresponding to the decision variable in which the solution is 0.

Here, in the second embodiment, the problem generation unit 28 generates a function illustrated in Formula (3) as an objective function in the QUBO problem.

$${\sum }_{i = 1}^{N} {\sum }_{j = 1}^{N} {x}_{i} \cdot {Q}_{i , j} \cdot {x}_{j} \qquad ( 3 )$$

Where, N is the number of nodes included in the strongly connected component as the target. i and j are integers of 1 or more and N or less, and represent indices of nodes.

xᵢ is a decision variable corresponding to the i-th node among the N nodes. xⱼ is a decision variable corresponding to the j-th node among the N nodes.

Q_{i,j} is a coefficient multiplied by a set of the decision variable corresponding to the i-th node and the decision variable corresponding to the j-th node included in the QUBO matrix.

In the second embodiment, the QUBO matrix is an N×N square matrix. In the second embodiment, the QUBO matrix is set such that the objective function has a minimum value in a case where the number of unconnected nodes in each of the two or more nodes included in the partial graph becomes the second set value.

In the second embodiment, Q_{i,j}, which is a coefficient included in the QUBO matrix, is expressed by Formula (4).

$${Q}_{i , j} \{ \begin{matrix}- 1 & if i = j \\ 0 & if i \neq j ∧ ( i , j ) ∈ Edges \\ \frac{1}{1 + β} & if i \neq j ∧ ( i , j ) ∉ Edges\end{matrix} \qquad ( 4 )$$

Where, Q_{i,j} is a coefficient multiplied by a set of the decision variable corresponding to the i-th node and the decision variable corresponding to the j-th node. Edges represents a set of a plurality of edges included in the strongly connected component as the target. (i,j) represents an edge that exits from the i-th node and enters the j-th node.

Therefore, Q_{i,j} expressed by Formula (4) is −1 as a coefficient corresponding to the same set of nodes. A coefficient corresponding to a set of different nodes is set to 0 in a case where the nodes are connected by an edge, and is set to 1/(1+β) in a case where the nodes are not connected by an edge. β is a positive real number and corresponds to the second set value. For example, an initial value of β is set by a user or the like.

The objective function including the QUBO matrix calculated according to Formula (4) has a minimum value in a case where values of the N decision variables are selected such that the number of unconnected nodes in each of the two or more nodes included in the partial graph is β. That is, the QUBO problem using the objective function including the QUBO matrix calculated according to Formula (4) returns the global minimum value in the vicinity where the number of unconnected nodes in each of the two or more nodes included in the partial graph is β.

Therefore, the QUBO problem using the objective function including the QUBO matrix calculated according to Formula (4) can return a solution that leaves the nodes in which the number of unconnected nodes is less than or equal to β except for the nodes in which the number of unconnected nodes is larger than β among the strongly connected components as the target. Therefore, the QUBO problem using the objective function including the QUBO matrix calculated according to Formula (4) can return a solution for selecting a partial graph including the two or more nodes densely connected to each other, excluding a simple closed circuit with a large number of edges, while leaving a simple closed circuit with a small number of edges.

Note that the QUBO matrix is not limited to the matrix shown in Formula (4), and may be another matrix. For example, the QUBO matrix may be a matrix obtained by multiplying the matrix shown in Formula (4) by coefficients. Furthermore, a coefficient corresponding to a set of different nodes connected by an edge in the QUBO matrix may be 1/(B+β). Note that B is a positive integer.

Subsequent to S32, in S17, the repetition control unit 36 detects the number of edges of the partial graph. Subsequently, in S18, the repetition control unit 36 determines whether or not the number of edges included in the generated partial graph is less than or equal to a preset threshold value for the strongly connected component as the target. In a case where the number of edges included in the generated partial graph is larger than the threshold value (No in Step S18), the repetition control unit 36 advances the processing to S33.

In S33, the repetition control unit 36 decreases β used for calculation of the QUBO matrix by a predetermined amount. After completing S33, the repetition control unit 36 returns the processing to S31. Then, the problem generation unit 28 repeats the processing from S31.

The number of edges included in the partial graph increases as the total of the entire partial graphs of the number of unconnected nodes in the nodes increases. Therefore, the number of edges included in the partial graph is proportional to β. Therefore, the repetition control unit 36 can control the number of edges included in the partial graph to a target value by changing β and repeating generation of the QUBO problem and generation of the partial graph. For example, the repetition control unit 36 can control the number of edges included in the partial graph to the target value by the binary search.

In a case where the number of edges included in the partial graph is less than or equal to the threshold value (Yes in Step S18), the repetition control unit 36 advances the processing to S20.

In S20, the simple closed circuit detection unit 34 detects a simple closed circuit included in the partial graph for each of the strongly connected components as the target.

In S21, the path detection device 10 determines whether or not the processing from S31 to S20 has been executed for all of the one or the plurality of strongly connected components. In a case where the execution has not been completed for all of the one or the plurality of strongly connected components, the path detection device 10 executes the processing from S31 to S20 for the unexecuted strongly connected component. In a case where the processing from S31 to S20 has been completed for all of the one or the plurality of strongly connected components, the path detection device 10 advances the processing to S22.

In S22, the output unit 38 outputs the simple closed circuits detected for all of the one or the plurality of strongly connected components. Upon completion of S22, the path detection device 10 ends this flow.

The path detection device 10 according to the second embodiment as described above detects, for each of the one or the plurality of strongly connected components included in the directed graph, partial nodes so as not to exclude nodes having a small number of unconnected nodes except for a node having a large number of unconnected nodes. As a result, the path detection device 10 can detect a partial graph obtained by removing a simple closed circuit having a large number of edges from the directed graph with high probability.

Then, the path detection device 10 detects the simple closed circuit from such a partial graph. Therefore, the path detection device 10 can detect the simple closed circuit with a small number of edges included in the directed graph with a small calculation time and a small calculation space.

Hardware Configuration

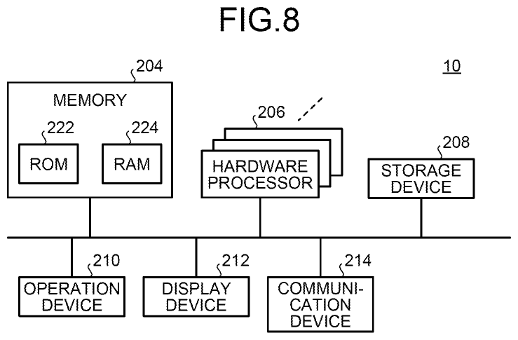

FIG. 8 is a hardware block diagram of the path detection device 10. As an example, the path detection device 10 is realized by a hardware configuration similar to that of a general computer (information processing device) as illustrated in FIG. 8. The path detection device 10 may be realized by one computer or server as illustrated in FIG. 8, or may be realized by a plurality of computers or servers operating in cooperation. Alternatively, the path detection device 10 may partially include a dedicated hardware circuit.

The path detection device 10 includes a memory 204, one or a plurality of hardware processors 206, a storage device 208, an operation device 210, a display device 212, and a communication device 214. Each unit is connected by a bus.

The memory 204 includes, for example, a ROM 222 and a RAM 224. The ROM 222 non-rewritably stores programs, various setting information, and the like used for controlling the path detection device 10. The RAM 224 is a volatile storage medium such as a synchronous dynamic random access memory (SDRAM). The RAM 224 functions as a work area of one or a plurality of hardware processors 206.

The one or the plurality of hardware processors 206 are connected to the memory 204 (the ROM 222 and the RAM 224) via a bus. Each of the one or the plurality of hardware processors 206 may be, for example, a central processing unit (CPU) or a hardware circuit for calculation.

The one or the plurality of hardware processors 206 execute various processing in cooperation with various programs stored in advance in the ROM 222 or the storage device 208 using a predetermined area of the RAM 224 as a work area, and integrally control the operation of each unit constituting the path detection device 10. Furthermore, the one or the plurality of hardware processors 206 control the operation device 210, the display device 212, the communication device 214, and the like in cooperation with a program stored in advance in the ROM 222 or the storage device 208.

The storage device 208 is a rewritable recording device such as a semiconductor storage medium such as a flash memory or a magnetically or optically recordable storage medium. The storage device 208 stores programs, various setting information, and the like used for controlling the path detection device 10.

The operation device 210 is an input device such as a mouse and a keyboard. The operation device 210 receives information input by operation from the user, and outputs the received information to the one or the plurality of hardware processors 206.

The display device 212 displays information to the user. The display device 212 receives information and the like from the one or the plurality of hardware processors 206, and displays the received information. Note that, in a case where information is output to the communication device 214, the storage device 208, or the like, the path detection device 10 may not include the display device 212. The communication device 214 communicates with an external device to transmit and receive information via a network or the like.

The program executed by the path detection device 10 according to the present embodiment is provided by being recorded in a computer-readable recording medium such as a CD-ROM, a flexible disk (FD), a CD-R, or a digital versatile disk (DVD) as a file in an installable format or an executable format.

Furthermore, the program executed by the path detection device 10 of the present embodiment may be stored on a computer connected to a network such as the Internet and provided by being downloaded via the network. Furthermore, the program executed by the path detection device 10 of the present embodiment may be provided or distributed via a network such as the Internet. Furthermore, the program executed by the path detection device 10 of the present embodiment may be provided by being incorporated in a ROM or the like in advance.

The program for causing the information processing device to function as the path detection device 10 has a module configuration including, for example, a graph acquisition module, a strongly connected component detection module, a problem generation module, a solution acquisition module, a partial graph generation module, a simple closed circuit detection module, a repetition control module, and an output module. Moreover, the program may include a QUBO solver module. The program is executed by the one or the plurality of hardware processors 206 to load each module into the RAM 224 of the memory 204, and causes the one or the plurality of hardware processors 206 to function as the graph acquisition unit 24, the strongly connected component detection unit 26, the problem generation unit 28, the solution acquisition unit 30, the partial graph generation unit 32, the simple closed circuit detection unit 34, the repetition control unit 36, and the output unit 38. Moreover, the program may cause the one or the plurality of hardware processors 206 to function as the QUBO solver 22. Note that some or all of these configurations may be configured by hardware.

Although some embodiments herein have been described, these embodiments have been presented as examples, and are not intended to limit the scope of the invention. These novel embodiments can be implemented in various other forms, and various omissions, substitutions, and changes can be made without departing from the gist of the invention. These embodiments and modifications thereof are included in the scope and gist of the invention, and are included in the invention described in the claims and the equivalent scope thereof.

What is claimed is:

1. A path detection device that detects a simple closed circuit included in a directed graph, the path detection device comprising:
one or more hardware processors configured to function as:
a strongly connected component detection unit that detects one or a plurality of strongly connected components included in the directed graph;
a problem generation unit that generates a quadratic unconstrained binary optimization (QUBO) problem for each of the one or the plurality of strongly connected components;
a solution acquisition unit that acquires a solution of the QUBO problem for each of the one or the plurality of strongly connected components;
a simple closed circuit detection unit that detects the simple closed circuit included in a partial graph for each of the one or the plurality of strongly connected components; and
an output unit that outputs information specifying the detected simple closed circuit, wherein
a plurality of decision variables included in an objective function in the QUBO problem corresponds to a plurality of nodes or a plurality of edges included in a strongly connected component as an target among the one or the plurality of strongly connected components,
the partial graph is a part including two or more nodes or two or more edges selected based on the solution in the strongly connected component as the target, and
a QUBO matrix included in the objective function is set such that the objective function is minimized in a case where the partial graph satisfies a preset condition.

2. The path detection device according to claim 1, wherein
the plurality of decision variables corresponds to the plurality of edges included in the strongly connected component as the target, and
the QUBO matrix is set such that the objective function is minimized in a case where an addition value of an input order and an output order in each of the two or more nodes included in the partial graph becomes a first set value.

3. The path detection device according to claim 2, wherein
the problem generation unit generates the objective function represented by Formula (1) described below,
$${\sum }_{i = 1}^{E} {\sum }_{j = 1}^{E} {x}_{i} \cdot {Q}_{i , j} \cdot {x}_{j} \qquad ( 1 )$$
where, i and j are integers of 1 or more and E or less,
E is a number of the plurality of edges included in the strongly connected component as the target,
xᵢ is a decision variable corresponding to an i-th edge,
xⱼ is a decision variable corresponding to a j-th edge, and
Q_{i,j} is a coefficient multiplied by a set of the decision variable corresponding to the i-th edge and the decision variable corresponding to the j-th edge included in the QUBO matrix.

4. The path detection device according to claim 3, wherein
Q_{i,j} is represented by Formula (2) described below,
$${Q}_{i , j} = {Q}_{i , j}^{α} + {Q}_{i , j}^{source} + {Q}_{i , j}^{destination} \qquad ( 2 )$$
$${Q}_{i , j}^{α} = \{ \begin{matrix}- 4 α & if i = j \\ 0 & if i \neq j\end{matrix}$$
$${Q}_{i , j}^{source} = \{ \begin{matrix}+ 1 & if {source}_{i} = {source}_{j} \\ 0 & if {source}_{i} \neq {source}_{j}\end{matrix}$$
$${Q}_{i , j}^{destination} = \{ \begin{matrix}+ 1 & if {destination}_{i} = {destination}_{j} \\ 0 & if {destination}_{i} \neq {destination}_{j}\end{matrix}$$
where, Q^{α}_{i,j} is a first term of the coefficient multiplied by the set of the decision variable corresponding to the i-th edge and the decision variable corresponding to the j-th edge,
Q^{source}_{i,j} is a second term of the coefficient multiplied by the set of the decision variable corresponding to the i-th edge and the decision variable corresponding to the j-th edge,
Q^{destination}_{i,j} is a third term of the coefficient multiplied by the set of the decision variable corresponding to the i-th edge and the decision variable corresponding to the j-th edge,
α is a positive real number,
sourceᵢ represents an original node of the i-th edge,
sourceⱼ represents an original node of the j-th edge,
destinationᵢ represents an output destination node of the i-th edge, and
destinationⱼ represents an output destination node of the j-th edge.

5. The path detection device according to claim 4, wherein
the one or more hardware processors are configured to further function as:
a repetition control unit that causes generation of the QUBO problem and acquisition of the solution of the QUBO problem to be repeated for each of the one or the plurality of strongly connected components,
the repetition control unit causes generation of, in second and subsequent generation processing of the QUBO problem, a new QUBO problem by using a new a decreased by a predetermined amount from a used in immediately previous processing, and
in a case where a number of edges included in the partial graph is less than or equal to a threshold value, the repetition control unit terminates repetition processing, and causes detection of the simple closed circuit included in the partial graph.

6. The path detection device according to claim 1, wherein
the plurality of decision variables corresponds to the plurality of nodes included in the strongly connected component as the target, and
the QUBO matrix is set such that the objective function has a minimum value in a case where a number of unconnected nodes in each of the two or more nodes included in the partial graph becomes a second set value.

7. The path detection device according to claim 6, wherein
the objective function is expressed by Formula (3) described below,
$${\sum }_{i = 1}^{N} {\sum }_{j = 1}^{N} {x}_{i} \cdot {Q}_{i , j} \cdot {x}_{j} \qquad ( 3 )$$
where, i and j are integers of 1 or more and N or less,
N is a number of the plurality of nodes included in the strongly connected component as the target,
xᵢ is a decision variable corresponding to an i-th node,
xⱼ is a decision variable corresponding to a j-th node, and
Q_{i,j} is a coefficient multiplied by a set of the decision variable corresponding to the i-th node and the decision variable corresponding to the j-th node included in the QUBO matrix.

8. The path detection device according to claim 7, wherein
Q_{i,j} is represented by Formula (4) described below,
$${Q}_{i , j} \{ \begin{matrix}- 1 & if i = j \\ 0 & if i \neq j ∧ ( i , j ) ∈ Edges \\ \frac{1}{1 + β} & if i \neq j ∧ ( i , j ) ∉ Edges\end{matrix} \qquad ( 4 )$$
where, β is a positive real number,
Edges is a set of edges included in the strongly connected component as the target, and
(i,j) is an edge from the i-th node toward the j-th node.

9. The path detection device according to claim 8, wherein
the one or more hardware processors are configured to further function as:
a repetition control unit that causes generation of the QUBO problem and acquisition of the solution of the QUBO problem to be repeated for each of the one or the plurality of strongly connected components,
the repetition control unit causes generation of, in second and subsequent generation processing of the QUBO problem, a new QUBO problem by using a new β decreased by a predetermined amount from β used in immediately previous processing, and
in a case where a number of edges included in the partial graph is less than or equal to a threshold value, the repetition control unit terminates repetition processing, and causes detection of the simple closed circuit included in the partial graph.

10. A computer program product having a non-transitory computer readable medium including programmed instructions, wherein the instructions, when executed by a computer of an information processing device configured to function as a path detection device that detects a simple closed circuit included in a directed graph, cause the computer to function as:
a strongly connected component detection unit that detects one or a plurality of strongly connected components included in the directed graph;
a problem generation unit that generates a quadratic unconstrained binary optimization (QUBO) problem for each of the one or the plurality of strongly connected components;
a solution acquisition unit that acquires a solution of the QUBO problem for each of the one or the plurality of strongly connected components;
a simple closed circuit detection unit that detects the simple closed circuit included in a partial graph for each of the one or the plurality of strongly connected components; and
an output unit that outputs information specifying the detected simple closed circuit, wherein
a plurality of decision variables included in an objective function in the QUBO problem corresponds to a plurality of nodes or a plurality of edges included in a strongly connected component as an target among the one or the plurality of strongly connected components,
the partial graph is a part including two or more nodes or two or more edges selected based on the solution in the strongly connected component as the target, and
a QUBO matrix included in the objective function is set such that the objective function is minimized in a case where the partial graph satisfies a preset condition.
